(19) United States
(12) Patent Application Publication
(10) Pub. No.: US 2014/0279408 A1
(43) Pub. Date: Sep. 18, 2014

(54) METHODS AND SYSTEMS FOR FACILITATING AND MONITORING CHARITABLE DONATIONS BASED ON PAYMENT CARD LOYALTY CONTRIBUTIONS

(71) Applicants: Jonathan Bowles, Odiham (GB); Helen Kim Orlando, London (GB)

(72) Inventors: Jonathan Bowles, Odiham (GB); Helen Kim Orlando, London (GB)

(21) Appl. No.: 13/801,107

(22) Filed: Mar. 13, 2013

(51) Int. Cl. G06Q 20/22

(52) U.S. Cl. CPC G06Q 20/29; G06Q 30/0279
USPC 705/39

(57) ABSTRACT

A charitable donation system that facilitates and monitors charitable donation based on payment card loyalty contributions is disclosed. A simple web-based tool that allows people to join as members, authorize their loyalty contributions offered by payment card companies to be used for charitable donations, and to select which charity the member chooses to receive the loyalty contributions. The loyalty contributions are provided to the member-selected charity in the form of a pre-paid debit card which may only be used for direct, authorized purchases. The charitable donation system monitors and analyzes the charity's purchases and provides purchase information associated with the charity's purchase to the member. The charitable donation system provides a potentially, long-term stream of contributions which may continue indefinitely without further member involvement.

### BACKGROUND OF THE INVENTION

1. Field of the Invention

The present invention relates in general to charitable donations. More particularly, the invention is directed to using credit/debit card loyalty points to fund member selected charities.

2. Description of the Related Art

Charities play a vital role by giving aid and assistance to people throughout the world. However, many people are reluctant to give to charities for a variety of reasons. Some people believe that their small donations will not actually make a difference. Others are suspicious as to whether their donations will go to those in need or instead be used to cover administrative fees and other inappropriate expenditures.

Accordingly, a need exists to improve the process for soliciting and monitoring charitable donations and generating enhanced outcomes.

### SUMMARY OF THE INVENTION

In a first aspect, a method is provided for facilitating charitable donations. The method comprises employing one or more processors for enabling a member to select a member-selected charity for receiving a charitable donation based on a purchase made by the member using a member payment card, receiving an identity of the member-selected charity and member payment card information from the member, and receiving transactional information for the purchase involving the member payment card. One or more processors are further employed for assigning the charitable donation to a member escrow account for the member-selected charity, facilitating the transfer of the charitable contribution to the member-selected charity.

In a preferred embodiment of the method, receiving the identity of the member-selected charity and the member payment card information preferably further comprises displaying on a secure webpage to the member, a listing of charities available for selection, and receiving the identity of the member-selected charity from the member using an Internet Connected Computing Device. Facilitating the transfer of the charitable contribution to the member-selected charity preferably further comprises calculating a total amount in the member escrow account, determining whether the total amount in the member escrow account exceeds a predetermined threshold, assigning a pre-paid debit card to the member-selected charity, the pre-paid debit card having a value of that deducted from the member escrow account, and sending the pre-paid debit card to the member-selected charity. The method preferably further comprises monitoring purchases made by the member-selected charity, and invalidating the pre-paid card if the charity has not made a purchase with the pre-paid card within a predetermined time period. The method preferably further comprises receiving transaction information for the pre-paid debit card made by the member-selected charity, and displaying the purchase information for the pre-paid debit card to the member.

The method preferably further comprises providing a means for the member to object to the transaction information for the pre-paid card on basis of fraud, receiving the member objection, and determining whether the transaction for the pre-paid card is fraudulent. The method preferably further comprises stopping a payment of the pre-paid transaction if the transaction has been determined to be fraudulent. The method preferably further comprises displaying on a secure webpage, a means for the member to elect and participate in a prize draw, and receiving a prize draw participation status. The method preferably further comprises receiving funds from revenue sources, randomly assigning a portion of the funds into a member account, and notifying the member of assignment of the funds into a member account. At least a portion of the revenue sources preferably comprise government refunds associated with charitable donations. The method preferably further comprises receiving from the member a request to solicit a matching donation from another member, informing other members of the request to solicit the matching donation, receiving a matching donation from said another member, and donating the member donation and the matching donation to the member-selected charity. The charitable donation preferably comprises a loyalty contribution which is deducted from an associated payment to a merchant identified in the transactional information.

In a further aspect, a charitable donation system comprises a memory comprising member and charity information and a processor. The processor is operably connected to the memory and a payment card processing system and configured for receiving an identity of a member-selected charity and member payment card information from a member, receiving transactional information from the payment card processing system for a purchase made by the member using the member payment card, assigning a charitable donation to a member escrow account for the member-selected charity based on the purchase made by the member, facilitating the transfer of the charitable contribution to the member-selected charity, and monitoring via the payment card company transactions associated with the charitable contribution.

In a preferred embodiment, receiving the identity of the member-selected charity and the member payment card information preferably further comprises displaying on a secure webpage, a listing of charities available for selection, and receiving the identity of the member-selected charity using an Internet Connected Computing Device.

Facilitating the transfer of the charitable contribution to the member-selected charity preferably further comprises determining a total amount in the member escrow account, determining whether the total amount in the member escrow account exceeds a predetermined threshold, assigning a pre-paid debit card to the member-selected charity, the pre-paid debit card having a value of that deducted from the member escrow account, and sending the pre-paid debit card to the member-selected charity. The processor is preferably further configured for receiving transaction information for the pre-paid debit cards, and displaying the transactional information for the pre-paid debit card to the member.

In a further aspect, a charitable donation system comprises a memory comprising member and charity information and a processor. The processor is operably connected to the memory and configured for processing payment card transactions with merchants, receiving an identity of a member-selected charity and member payment card information from a member, receiving transactional information for a purchase made by the member using the member payment card, assigning a charitable donation to the member escrow account for the member-selected charity based on the purchase made by the member, and facilitating the transfer of the charitable contribution to the member-selected charity.

In a preferred embodiment, receiving the member-selected charity and the member payment card information preferably further comprises displaying on a secure webpage, a listing of charities available for selection, and receiving the identity of the member-selected charity using an Internet Connected Computing Device. Facilitating the transfer of the charitable contribution to the member-selected charity preferably further comprises determining a total amount in the member escrow account, determining whether the total amount in the member escrow account exceeds a predetermined threshold, assigning a pre-paid debit card to the member-selected charity, the pre-paid debit card having a value of that deducted from the member escrow account, and sending the pre-paid debit card to the member-selected charity. The processor is preferably further configured for receiving transaction information for the pre-paid debit cards, and displaying the transactional information for the pre-paid debit card to the member.

A method is also provided for monitoring financial transactions of a charity comprising employing one or more processors for receiving charity purchase information of a financial transaction of a charity, retrieving charity profile information, retrieving charity compliance rules, determining whether the financial transaction of a charity complies with the charity compliance rules, and if the financial transaction of the charity does not comply with the charity compliance rules, alerting a donating party of the lack of compliance.

In a preferred embodiment, the charity profile information preferably comprises a charity transactional archive and charity donation restrictions. The charity donation restrictions preferably comprise restrictions imposed by a donation facilitation party. The charity compliance rules are preferably based on one or more of the following: the function of the charity, the intended beneficiaries of the charity, the frequency of the purchase of specific items, and the supplier profile. The method preferably further comprises estimating a level of compliance of the transaction. Alerting the donating party of the lack of compliance preferably further comprises presenting the level of compliance of the transaction to the donating party. Presenting the level of compliance of the transaction to the donating party preferably further comprises presenting specific icons on a webpage which reflects the level of compliance. The method preferably further comprises stopping a payment of the pre-paid transaction if the transaction has been determined to be fraudulent. The method preferably further comprises receiving an objection from a donating party, and stopping a payment of the pre-paid transaction. The financial transaction of a charity is preferably made with a pre-paid debit card. Receiving charity purchase information of a financial transaction of a charity is preferably provided by a debit card processing system. The method preferably further comprises monitoring the transactions of the charity, and invalidating the pre-paid card if the charity has not made a purchase with the pre-paid card within a predetermined time period.

In a further aspect, a charitable donation system comprises a memory comprising charity profile information and charity compliance rules and a processor. The processor is operably connected to the memory and a credit card processing system, the processor configured for receiving charity purchase information of a financial transaction of a pre-paid card issued to a charity, retrieving charity profile information, retrieving charity compliance rules, determining whether the financial transaction of a charity complies with the charity compliance rules, and if the financial transaction of the charity does not comply with the charity compliance rules, alerting a donating party of the lack of compliance.

In a preferred embodiment, the charity profile information preferably comprises a charity transaction archive and charity donation restrictions. The charity compliance rules are preferably based on one or more of the following: the function of the charity, the intended beneficiaries of the charity, the frequency of the purchase of specific items, and the supplier profile. The processor is preferably further configured for estimating a level of compliance of the transaction, and presenting the level of compliance of the transaction to a donating party.

In a further aspect, a charitable donation system comprises a memory comprising charity profile information and charity compliance rules and a processor. The processor is operably connected to the memory and configured for processing credit card transactions with merchants, receiving charity purchase information of a financial transaction of a charity, retrieving charity profile information, retrieving charity compliance rules, determining whether the financial transaction of a charity complies with the charity compliance rules, and if the financial transaction of the charity does not comply with the charity compliance rules, alerting a donating party of the lack of compliance.

In a preferred embodiment, the charity profile information preferably comprises a charity transaction archive and a charity donation restrictions. The charity compliance rules are preferably based on one or more of the following: the function of the charity, the intended beneficiaries of the charity, the frequency of the purchase of specific items, and the supplier profile. The processor is preferably further configured for estimating a level of compliance of the transaction, and presenting the level of compliance of the transaction to a donating party.

These and other features and advantages of the invention will become more apparent with a description of preferred embodiments in reference to the associated drawings.

### DESCRIPTION OF THE DRAWINGS

FIG. 1 is a block, schematic flow chart illustrating a charitable donation process in one or more embodiments.

FIG. 2 is a schematic block diagram of a charitable donation system using a member's payment card loyalty contributions in one or more embodiments.

FIG. 3 is a schematic block diagram of a charitable donation system based on a network in an embodiment.

FIG. 4 is a schematic block diagram of a charitable donation facilitator in an embodiment.

FIG. 5 is a schematic block diagram of multiple computer systems forming a charitable donation system.

FIG. 6 is a schematic block diagram of a single computer system forming a charitable donation system.

FIG. 7 is a flow diagram illustrating the overall process flow of a charitable donation system in an embodiment.

FIG. 8 is a flow diagram illustrating the process of establishing member accounts in an embodiment.

FIG. 9 is a flow diagram illustrating the process of establishing a charitable donation based on the member's payment card loyalty contributions.

FIG. 10 is a flow diagram illustrating the process of monitoring the purchase by the member-selected charity and informing the member of the purchase.

FIG. 11 is a flow diagram illustrating the process of a incorporating a prize draw for incentivizing the member to continue participating in the charitable donation system.

### DETAILED DESCRIPTION OF THE PREFERRED EMBODIMENTS

The following preferred embodiments are directed to methods and system for facilitating charitable donations based on members' registered payment card loyalty contributions. In an embodiment, the charitable donation system provides a simple online web-based tool or an application available via an Internet connected computing device such as a computer, laptop, smart phone, tablet, or any other device capable of connecting to the Internet (hereafter “Internet Connected Computing Device”). The Internet Connected Computing Device would employ software applications that allows people to join as members, authorize their loyalty unrestricted cash contributions offered by payment card companies to be used for charitable donations only, and select which registered charity the member chooses to receive the loyalty contributions. The loyalty contributions are provided to the member-selected charity in the form of a pre-paid debit card in their name and control which may be used only for direct purchases. The charitable donations system encourages charities not to direct member funds to overheads without the members' prior approval. As such, the member knows that 100% of the donation will be used for charitable purposes. Moreover, the charitable donation system provides the members with purchase information associated with the charity's purchases. In an embodiment, the charitable donation system will incorporate “prize draws” based on other revenue sources such as tax refunds by a central government such as a gift aid. Members may also request other members, via an online posting, to make matching contributions to double the amount of money donated to the selected registered charity. The charitable donation system provides a long-term stream of contributions which may continue indefinitely without further member involvement.

As used herein, the term “payment card” may refer generally to a credit card, a debit card, a charge card, or a cash card, as well as other payment systems which do not rely on physical plastic such mobile devices and smartphones with the ability to engage in purchase transactions. The terms “payment card company” and “payment card processor” refer to the entities or systems which enables cardholders to make purchases with payment cards, repays the merchants, and tracks and archives the payment card transactional information.

While specific values are provided herein such as for dollar amounts, time limits, and other parameters, it shall be understood that the specific values listed are for illustration purposes only and the parameters may have differing values or may be later changed.

The systems comprising multiple controllers and entities disclosed herein are for illustration purposes only as other combinations of entities, such a combination of a merchant and payment card company for example, are contemplated in one or more embodiments.

In one or more embodiments, an “Internet Connected Computing Device” or “ICCD” may refer generally to electronic devices which may interact over a network such as the Internet, such as, but not limited to, computers, laptops, tablets, smart phones, devices using custom software applications (e.g. readers), and mobile connected computing devices.

FIG. 1 is a block, schematic flow chart illustrating a charitable donation process 101 in one or more embodiments. In one or more embodiments, a customer, or member, 110 interacts with the charitable donation system using web-based management tools 114 via devices such as computers, laptops, tablets, or smart phones employing applications to establish an account. The web-based management tool 114 may provide downloadable applications specific for commercially available smart phones, tablets, computers, laptops, or mobile devices. The web-based management tool 114 may comprise a secure PCI compliant webpage in one or more embodiments. The member selects a member-selected registered charity in an embodiment. The approved member 110 purchases an item and merchant transfers a percentage of the purchase price at block 112. The charitable donation system donates funds to the charity 116 via pre-paid debit cards. The charity 116 then makes purchases with the vendors/suppliers 118.

A simple online web-based lifestyle management tool 114 interacts with ICCDs such as ICCD 203 illustrated in FIG. 3 and described below which allow any member of the public, as a registered member that subscribes or registers for free, to generate free “new” money, that can only to be used as their charitable donations, following any of their “spend’” transactions, or simply “spend,” from any of their existing registered payment cards. The member will generate a charitable donation every time they use their cards to purchase from an eligible merchant at no additional cost to the member as the member accounts collect an agreed percentage of their sale from the merchant which varies between merchants and retailers 112 as a loyalty contribution. Once registered, a member 110 does not need to visit the web site again if he or she does not want to, other than to change their details if necessary or direct their donations.

The system 101 is designed to be self-supporting and run preferably for free as a statement of the purity of private supporters being able to give 100% to charity from the percentage the generated funds from their card spending. Members 110 collect and distribute donations without cost, which reinforces the power of member generosity without deductions for commercial interests in enabling the service.

Members can use the web site or web application to shop via commercial links to secure more free or greater donations. The membership also works with registered cards in store so there would, in the latter case, be no behavioral change from a customer's previous shopping behavior before entering the charitable donation membership.

In one or more embodiments, the vendor recipient 118 of a member's card spend donates a percentage of their sale to the members' virtual charity account as an automatic feeder. The amount will vary between merchants 112 depending on the contract in which they have entered.

The merchant 112 sees that donation transaction being a loyalty inducement to retain and or secure that customer 110 and enjoy the new business that is driven from the charitable donation web sales platform via the online engagement with its members 110.

A percentage of each member payment is given by a merchant direct to the card holders' virtual charity locked account. The merchant has received financial benefit from a member, which is then partly converted to a donation against payment for services or products, and then seen by the merchant as loyalty payments under their contract. “New” funds are generated by the charitable donation system that the member 110 could not access without being a member.

Among the benefits of one or more embodiments include the simple online web-based tool 114 which interacts with ICCDs that allows the charitable donation system 110 to track where donations are going, donate to whatever charity they want, and contact them if not appropriate spend. Itemized receipts offer complete transparency which is self monitoring and community driven. The charitable donation system tracks the spending of each charity to ensure the donation is spent within a set time scale and on appropriate projects. Charities are required to spend the donation along with providing access qualifying that expenditure. Embodiments create an environment in which purchasing power is increased and ultimately increases supply chain flow. Social crowd sourcing of the charities' spending is based on preferred suppliers. The charitable donation system reserves the right to shut down the suppliers when abuse is known as the ‘closed loop’ card has this capability.

In one or more embodiments, a recipient charity 116 in effect contracts with a donor 110 when they receive a donor's money. The charity 116 receives the donation on the basis they use that money to create value for those they serve. There is no current means of generating any certainty of a positive outcome. Preferred embodiments herein offer a new way of giving what non-members cannot access and what members voluntarily chose to generate for charitable good. “Giving” becomes receiving as well, due to the process mapping and short time scale of the charitable donation system.

The member 110 can continue their life in the same charitable way with an option of knowing what the charitable donation system delivers for them and that they do not need to participate, or do anything other than engage by becoming a member. If the former they have secured a relationship that runs parallel to their daily life whilst generating good that they control. If they exercise the option of knowing more, they can increase social benefit with minor deployment of their ability to engage more effectively so they can secure greater depth and meaning to their generosity in life. Indirectly, the rewards system generates a feeling that they are valued as members. Few systems exist to help address a stronger personal need that “we” like to have validation and encouragement for what we do whether charitable or not.

The member 110 may enjoy telling friends they are securing more emotional return and are proud of doing what they do at no cost to them.

Another advantage is the “friend” may become a member and use their donations to enrich that friendship by aligning with their friends' sponsored charities. It would be socially unacceptable to some people to expect their friends to give but maybe not so with the charitable donation system. The enablement process is being adapted to also transfer items not wanted by a member. And, therefore, the charitable donation system will become a commodity type bank. The accounts would therefore become repositories for other rewards offered by other organizations: air miles, coupons, etc., are examples.

A simple way of using one or more embodiments is where the member has a material gain of value by becoming a member and sees this balanced relationship leaving the member less inhibited as giving often results in the recipient looking subservient. The gain is only a thank you for collecting for “good.” An example would be when a proposed member becomes a member as they agreed to sponsor a magazine subscription of their choice as a magazine member recruitment initiative. A free film or a coffee gifted, when the member reaches a $50 threshold in their account, for example, and the transfer takes place. The selection of a $50 threshold is for illustration purposes as other values of the threshold amount are contemplated in one or more embodiments. The preferred embodiment could be slightly changed by the member having a pre-paid card so all their charity activities could run off that card.

The card would be a way of collating other membership cards in one to save mounds of plastic in a wallet. The card also encourages members to register with the charitable donations system in order to secure the charitable benefits associated with the card. While current member cards promote and manage members' benefits for them, the charitable donation system has no conflict of interest and could do this on their behalf. They would support this as their members could elect to have the charitable donation system renew their membership automatically by paying that sum if they become members for free.

Other features of these embodiments that the public can see for “free” is an immediate reduction to any cost that currently exists elsewhere which diminishes the value outcome of a donation. The outcome of a donation is greater by the charitable donation system integrated value assessment and the capability to further engage on behalf of the donor, as well as eradicating a diminution by taking out administration fees. As the system is mainly software based and there is significant third party infrastructure, the reliability is robust. The time for a donation to reach maturity in its deployment for good is radically reduced when it becomes a donation under the preferred charitable donation system. A donation will be processed to full maturity every time and not become a bank deposit pending an outcome which may never happen or be known to the donor. Most distribution channels are labor intensive but the charitable donation system donations can be self-administered as a member can elect to automatically repeatedly donate to their sponsored charity. Therefore the process continues in perpetuity on member spending with the members existing cards to their chosen charity.

The purpose of one or more embodiments is to grow member numbers so non-member donors have an alternative and could secure “new money” so they stop throwing potential cash rewards away and create a virtual account in their name to distribute the gain secured by the charitable donation system. Members are encouraged to engage their donor base to become members of the charitable donation system as their donors could raise more at no cost to themselves. Their supply chain beneficiaries are encouraged to become associated with the charitable donation system so they help increase charity member spend and they could therefore increase their sales revenue. Reasonably, the supply chain benefit exists as a result of donations and some charities may insist that recipients of their “spend” become members. This intelligent business model would increase leverage of the financial trail.

The charitable donations system may have terms and conditions which are based on quick deployment of donations to make a charitable difference—this is part of the USP and why members join. This includes donating to the prize draw as an option as described below. The advantage is that the charitable donations system exists in the first place and nothing else does that can claim a similar benefit or outcome for small donors whether their funds or charitable donations system generated funds. A donor can easily opt out at any time but why would they when there is no cost to them.

In an embodiment, the charitable donation system will eventually widen the potential recipients of raised member funds to include “not for profit or social enterprise” entities that the member considers worthy of financial support in that in the eyes of the member they create enhancement to the quality of life whether it be research and development or services/products. By employing a web-based system, charities may be able to attract additional donor members with the minimal administrative costs of maintaining an online presence. In addition, one or more embodiments of the charitable donation system may also reduce other infrastructure costs such as costs associated with providing donation stands, collection boxes, and support services for volunteers.

FIG. 2 is a schematic block diagram of a charitable donation system 201 using a member's payment card loyalty contributions in one or more embodiments. In one or more embodiments, the charitable donation system 201 employs one or more processors. In one or more embodiments, the charitable donations facilitator 220 via the intelligence and data module 222 and the controller 224 enables a member 210 to select a member-selected charity 240 for receiving a charitable donation 242 based on a purchase made by the member 210 using a member payment card. The charitable donation facilitator 220 may display on a secure webpage to the member 210, a listing of charities available for selection. The facilitator 220 then receives the identity of the member-selected charity 240 from the member 210 using a computer or smartphone for example.

A member's payment card (any provider) numbers, in part, are registered on line manually by them with the charitable donations facilitator 220 for their free membership. In the preferred embodiment, there cannot or would not be a charge against the partly registered cards. In any event, only part of the entire numbers are registered and not the security one for the system 201 to see or record these numbers as they are masked to their facilitator who deals with 10,000 banks. The member registration allows one to indirectly connect to the “end to end” payment processing from their members registered cards to create and collect cash incentives for the members charity account from participating merchants.

The payment card company 216 receives an identity of the member-selected charity 240 and a member 210 payment card information from the member 210. The member 210 makes a payment card purchase with a merchant 214 who is a part of the charitable donations network, and the payment card company 216 receives transactional information for the purchase involving the member payment card. The payment card company assigns a charitable donation to a member escrow account 218 for the member-selected charity 240. In an embodiment, the charitable donation comprises a loyalty contribution which is deducted from an associated payment to a merchant 214 identified in the transactional information.

A member's virtual account is “ring-fenced” cash by the payment card company 216 and cannot be accessed or used for the members' personal consumption as the members have pledged only to gift the amount to a registered charity of their choice as they have subscribed to system terms. The funds that are not “spend” restricted for the recipient charity other than timescale or recalled as fraudulent.

The virtual account currently needs to fill up to a threshold value such as $50 for example, then the auto system contacts that member to advise them that require details of their chosen charity so the donation can be transacted. If the member doesn't respond within a set time the sum is transferred to the Buildings Charity (100%), and they use the funds immediately to make a difference.

In an embodiment, the charitable donations facilitator 220 facilitates the transfer of the charitable contribution in the form of a pre-paid card 242 to the member-selected charity 240. In an embodiment, the payment card company calculates a total amount in the member escrow account 218 and determines whether the total amount in the member escrow account 218 exceeds a predetermined threshold. The payment card company 216 or the facilitator 220 assigns a pre-paid debit card 242 to the member-selected charity 240, the pre-paid debit card 242 having a value of that deducted from the member escrow account 218, and sends the pre-paid debit card 242 to the member-selected charity 240. For example, the virtual account currently needs to fill up to $50, for example, at which point the charitable donations facilitator 220 then contacts the member 210 to advise them that the facilitator 220 require details of their chosen charity so the donation can be transacted. If the member doesn't respond within a set time the entire sum is transferred to a Buildings Charity 232, and the Buildings Charity 232 may use the funds immediately to make a difference by directing 100% of the sum to a prize draw.

The member-selected charity 240 uses the pre-paid card 242 to make a purchase with the suppliers 250. The purchase compliance monitoring module 262 monitors and analyzes the transaction employing the controller and database 262 and reports the information to the charitable donations facilitator 220. The purchase compliance monitoring module 260 monitors purchases made by the member-selected charity 240 and invalidates the pre-paid card 242 if the charity 240 has not made a purchase with the pre-paid card within a predetermined time period, such as in any number of days, weeks or months. The time period for the receiving charity 240 to make the purchase is preferably predetermined by the charitable donations facilitator 220, although the preferred embodiment would enable a deadline to be suggested and/or implemented by others, such as members 210 or charities 240. In the preferred embodiment, the member 210 may specify that the member 210 prefers that the charity 240 makes the purchase by a shorter timeframe. This may spur the charity 240 to purchase more promptly, and thus gain the member's 210 loyalty for future donations. The purchase compliance monitoring module 260 also receives transaction information for the pre-paid debit card 242 made by the member-selected charity 240 and displays the purchase information for the pre-paid debit card to the member 210 via the charitable donation system 201. One or more embodiments provides a means for the member to object to the transaction information for the pre-paid card on basis of fraud such as by via email, member webpage, telephone, or mail. If the purchase compliance monitoring module 260 receives the member objection following payment and determines whether the transaction for the pre-paid card is fraudulent. The purchase compliance monitoring module 260 may also stop a payment of the pre-paid transaction if the transaction has been determined to be fraudulent.

The charity recipient member-selected charity 240 has to spend the money gifted and the money cannot be banked as the pre-paid card is a closed loop. This will ultimately be time limited (e.g., 30 days) otherwise those funds in the pre-paid card will be recalled as the member customer benefit is to know, under terms and conditions of the charitable donations system that this is the case. The time period for using the payment card may be different from 30 days in one or more embodiments.

The member 210 knows that the funds cannot be banked but has to be spent relatively quickly to make a difference and convert their financial sponsorship to “good” which hopefully enhances their emotional well-being knowing every time they use their card they know the charitable donations system will deliver an outcome for them.

The gifted funds have to transfer to a prepaid owned by the designated charity card 242 monitored by the payment card company 216 so the transactions are recorded as receipt information on the card reporting system and the member 210 can view on line the charity pre-paid card statement. This transparency is a key component of the overall system.

If the purchase compliance monitoring module 260 considers a charity purchase as very obviously inappropriate they will investigate so that the member 210 can be notified and any action by them considered in full knowledge of the recipient charity 240.

The charity 240 will need to accept terms, in that charitable donations system 201 is authorized to call any one (or company) receiving funds. The system 201 also reserves the right to stop, and, if possible, to recall the payment, if it can, provided the payment is considered being for a service or product that is blatantly inappropriate. Such action would be then reported to the member 210 and they can authorize it or elect to donate elsewhere. The system 201 may also include contractually that they have the right to acquire that product or service elsewhere, at a like for like, if they can secure it at a lower price as agent for the charity.

Membership allows any person with an income to generate funds from their spending without affecting their income, and therefore enable a donation to be made to a charity of their choice. This would usually only be for the domain of the privileged that can afford to deduct money from their earnings as they decided they have sufficient for their needs and chose to redistribute a donation amount. A low income earner can now have an opportunity to give charitably, as the donation doesn't come from their direct earning revenue but from their spending at no cost to them.

One or more embodiments include a way to create a “lottery type” concept without the necessity for a gaming license requirement. In a preferred embodiment, the system 201 receives funds from revenue sources 230, randomly assigns a portion of the funds into a member account, and notifies the member of assignment of the funds into a member account. The system 201 can and will randomly deposit funds into any of their member accounts 218, as the members 210 are not the recipients' donations generated from their spending, but merely allowing the member 210 to act as an agent empowered to donate further donations in excess of their own to whatever charity they choose. The prize draw, when won, reminds a member 210 that they are just as capable as any other in distributing to the needy via charitable means. This “prize draw” is not for any purpose other than giving away by the member to their chosen charity therefore it is not a lottery. This prize draw is free of any cost to the member 210. The member may elect to offer any sum for match which will include any charity notified donor or public to immediately participate alongside that sum.

In a preferred embodiment, the charitable donations facilitator 220 displays on a secure webpage, a means for the member to elect to participate in a prize draw and the charitable donations facilitator 220 receives a prize draw participation status. As discussed above, the member interacts with the charitable donation system using web-based management tools 114 via one or more ICCDs 203.

Assuming the member 210 selects the web based the charity information for which they are supporting, which may preferably comprise a dropdown box, the charitable donations facilitator 220 validates it is a registered charity then the sum will be transferred from the member escrow account 218 to the buildings charity management account 232.

The buildings charity 232 is contracted to then immediately transfer 100% of the donation to the designated member charity, preferably as a credit on their card. If the charity is not recognized by the charitable donations facilitator 220 then they will be contacted and advised that funds are held for their charity and they must take up registration to collect it as part of the terms and conditions which is a free service. When they are registered the funds will be credited to a pre-paid card in the charity name. The donation will be time limited for spending. The card will be issued and retained by them for future payments knowing the system has access to the spending receipts.

In one or more embodiments, at least a portion of the revenue sources comprise government refunds associated with charitable donations. In one or more embodiments, the Buildings Charity 232 will, as authorized by the member 210, apply to Central Government under the gift aid scheme to have credited to the buildings charity account 232 a refund of the tax paid on the sum the member 210 donated, assuming they qualify under the gift aid rules. The member 210 would have ticked a box, as a prefix unless “unticked” authorizing the Buildings Charity 232 to apply for a refund as they believe gift aid can be claimed against the donor member earnings.

The terms and conditions preferably state that the gift aid receipts will be randomly donated (100%) to members' escrow accounts 218 as a prize draw in different amounts until spent. If such sum singularly then exceeds the member's threshold, e.g., $50, in their virtual account, which normally it will do, the member is notified for instructions as to where the donation should be gifted. However, it is intended that a separate notification is made to the member 210 on Prize Draw donations so they understand they have won a prize sum. The total prize draw amount will be placed on the web site.

The funds are generated via several channels such as gift aid refunds, commercial sponsors, or the public or grant bodies who would normally donate to a charity but choose to donate to the prize draw as they get awareness marketing, or commercial or private match fund initiatives where a donor (they don't have to be members) places funds to be distributed by others as a reward (emotional) for being a member.

Hence, one or more embodiments offer several processes. In a first process, the funds when generated are held, in escrow in a client account held by cash back card; until a threshold such as $50 is reached, at which point the member is then notified to see who they want to receive the 100% donation of the sum in their account.

In a second process, when the member 210 confirms the funds are payable to a specific charity the funds are remitted to an aggregator platform, which is the Buildings charity 232 (registered at the UK charity commission). This charity secures gift aid as an authorized agent (a government rebate scheme to credit back tax paid by a UK tax payer, on that fund amount.) The initial member fund is immediately transferred then to the designated charity 240 unless the member decides to post the amount on the site to entice a match. If not the 100% charity the donation is transferred to the members sponsored charity prepaid card.

In a third process, the recipient charity of the donation are then free to spend the money, but not bank it as it has to go direct to discharge an appropriate supply chain bill. The charity pre-paid card statement can then be accessed by that donor member 210 for the member 210 to see where the funds went with a record of the supply chain recipient. The system 201 can then pick up a direct connection with that recipient and manage that outcome if appropriate or secure more detail for the members' knowledge. If the member 210 has, for example $35 in their escrow account 218, they can then undertake a voluntarily transfer of $15 from their private account via a credit/debit card to reach a predetermined threshold and trigger an account transfer to their virtual account as the account will have reached the minimum for transfer for a donation. This would be a voluntary act but not required as the system 201 is about free donations.

In a fourth process, the member 210 watches their account on line, if they want to, the random free prize draw outcome to see if they have had more funds gifted to them to give away. In one or more embodiments, the member 210 is contacted electronically such as by email message or text messaging. In one or more embodiments, the system 201 receives from the member 210 a request to solicit a matching donation from another member, informs other members of the request to solicit the matching donation, receives a matching donation from said another member, and donates the member donation and the matching donation to the member-selected charity 240. If so they would then be offered an alternative to gifting that sum and can opt to elect to attract a “match’” by allowing system 201 to post the sum on the website suggesting to any online reader (public or member) to also donate a similar sum. The Member 210 may interact with the website via an ICCD as illustrated in FIG. 3 and described below. The drop down instruction box allows either (a) any doubling can be at the request the original donor to go to their sponsored charity or (b) that they agree to the “matchers” nominated charity as a double donation.

FIG. 3 is a schematic block diagram of a charitable donation system 301 based on a network 202 in an embodiment. In one or more embodiments, multiple computer processors communicate and coordinate via a network 202. The network 202 may be the Internet or a private network. Such embodiments may enable separate, independent computer systems to interact to form the systems described herein.

FIG. 3 also shows an Internet Connected Computing Device 203 (“ICCD”) which enables the Member 210 to interact with the Network 202. The ICCD 203 may refer generally to devices such as, but not limited to, computers, laptops, tablets, smart phones, devices using custom software applications, and mobile connected computing devices for example.

In one or more embodiments, the Member 210 may comprise a Member Profile 211 which holds the profile information of the Member. The profile information may include personal information and the list of charities the Member 210 favors for example. The Member 210 would have the ability to control whether the Member Profile 211 may be viewed by the public, may be viewed by a group of persons selected by the Member 210, or may not be viewed by anyone other than the Member 210. Member Profiles 211 would allow for Members 210 to publicly display their support for certain selected charities while keeping other selected charities private.

In one or more embodiments, the Member Nominated Charity 240 may comprise a Charity Profile 241 which holds charity profile information of the Charity 240. Such charity profile information may include, for example, the beneficiaries of the Charity 240, the financial information of the Charity 240, the history of the Charity 240, and the Members who have donated to that Charity 240 and have granted permission for their support to be publicly known. The Charity 240 would have the ability to control whether the Charity Profile 241 may be viewed by the public, may be viewed by a group of persons selected by the Charity 240, or may not be viewed by anyone other than the Charity 240. In one or more embodiments, if the Charity 240 chooses that the Charity Profile 241 may be viewed by the general public, the Charity 240 may be perceived as being transparent as the Charity 240 may be exposed to public scrutiny.

FIG. 4 is a schematic block diagram of a charitable donations facilitator 260 in an embodiment. The charitable donations facilitator 220 comprises a memory 310 comprising member and charity information and a processor 304 operably connected to the memory 310 and a payment card processing system 216. The charitable donations facilitator 220 may also comprise RAM or ROM memory 306. The memory 310 may comprise multiple databases such as a customer profile database 312, a charity profile database 314, and a donation information database 316. The customer profile database 312 holds the account information for each of the members 210. As discussed above, each member's account information may also include all the member-selected charities to which the member has donated or would like to donate. In a preferred embodiment, an option exists to make the member's account information, or at least certain portions thereof, viewable to the public or to certain friend members who have permission to view a particular member's account information. This could facilitate greater awareness of different worthwhile charities, which in turn could spur new donations according to the preferred system from members who have recently become acquainted with these charities. The charity profile database 314 has a listing and profiles of the approved charities 240. The donation information database 316 archives the donations made to the charities.

The processor 304 is configured for receiving an identity of a member-selected charity 240 and member payment card information from a member 210, receiving transactional information from the payment card processing system for a purchase made by the member using the member payment card, and assigning a charitable donation to a member escrow account 218 for the member-selected charity 240 based on the purchase made by the member 210. The processor 304 is also configured for facilitating the transfer of the charitable contribution to the member-selected charity 240 and monitoring via the payment card company transactions associated with the charitable contribution.

The charitable donations facilitator 220 has a communication port 302 which hosts a browser application for interacting with the member 210. The charitable donations facilitator 220 receives the identity of the member-selected charity 240 and the member payment card information by displaying on a secure webpage, a listing of charities available for selection and receiving the identity of the member-selected charity using an ICCD 203 as illustrated in FIG. 3. The charitable donations facilitator 220 also tabulates a total amount in the member escrow account 218, determines whether the total amount in the member escrow account 218 exceeds a predetermined threshold, assigns a pre-paid debit card 242 to the member-selected charity 240, where the pre-paid debit card 242 has a value of that deducted from the member escrow account 218, and facilitates the sending of the pre-paid debit card 242 to the member-selected charity 240. The charitable donations facilitator 220 communicates with the purchase compliance monitoring module 260 and receives transaction information for the pre-paid debit cards 242 and displays the transactional information for the pre-paid debit card 242 to the member 210.

FIG. 5 is a schematic block diagram of multiple, separate computer systems forming a charitable donation system 401. The computer systems include a charitable donations facilitator 220, a purchase compliance monitoring module 260, and a payment card company 216. The payment card company may have a processor 404 with RAM 406 coupled to a database 410 holding the member database 412, member transactions database 414, and member escrow accounts 416.

In an embodiment, the charitable donations facilitator 220 and the purchase compliance monitoring module 260 may be hosted by a common computer system 480. FIG. 5 also depicts the purchase compliance monitoring module 260 comprising a memory 460 comprising charity profile information and charity compliance rules and a processor 454 operably connected to the memory 460 and a payment card processing system 262. The purchase compliance monitoring module 260 may also comprise RAM or ROM memory 456 as well as a communication port 452. The memory 460 may comprise a charity transaction archive database 462, a charity donation restriction database 464, and a compliance rules database 466. The processor 454 is configured for receiving charity purchase information of a financial transaction of a pre-paid card 224 issued to a charity 240, retrieving charity profile information, retrieving charity compliance rules, and determining whether the financial transaction of a charity complies with the charity compliance rules. The financial transaction of a charity 240 may be provided by a debit card processing system. If the financial transaction of the charity does not comply with the charity compliance rules, the processor 454 is configured for alerting a donating party of the lack of compliance. The charity profile information comprises information stored in the charity transaction archive 462 and charity donation restrictions stored in the charity donation restrictions database 464. The charity donation restrictions may comprise restrictions imposed by a donation facilitation party.

The charity compliance rules may be based one or several criteria such as the following: the function of the charity, the intended beneficiaries of the charity, the frequency of the purchase of specific items, and the supplier profile. For example, a charity that functions as a food program for the homeless would have a different set of rules for valid purchases than would a charity that offers disaster relief. Emergency shelter may be a valid purchase for the disaster relief charity but would likely be an invalid purchase for the food program charity. The processor 454 also estimates a level of compliance of the transaction and presents the level of compliance of the transaction to a donating party member 210. The member 210 is alerted of the lack of compliance further comprises presenting the level of compliance of the transaction to the donating party, such as by presenting specific icons on a webpage which reflects the level of compliance. The pre-paid transaction may be stopped if the transaction has been determined to be fraudulent. This may include receiving an objection from a donating party and stopping a payment of the pre-paid transaction. The charity transactions may be monitored, and the pre-paid card may be invalidated if the charity has not made a purchase with the pre-paid card within a predetermined time period.

FIG. 6 is a schematic block diagram of a single computer system forming a charitable donation system 501 having similar functions as the system 401 displayed in FIG. 5. The charitable donation system 501 has a central processing facility 501 which comprises a memory 510 comprising member and charity information, and a processor 504 operably connected to the memory 510. The central processing facility 500 also has a communication port 502 and RAM/ROM memory 506. The memory 510 may comprise several databases having functions similar to the databases described above including databases for customer profiles 512, charity profiles 514, donation information 516, member profiles 518, member transactions 520, member escrow accounts 522, charity transactions archive 524, charity donation restrictions 526, and compliance rules 528.

The processor 504 is configured for processing payment card transactions with merchants, receiving an identity of a member-selected charity 240 and member payment card information from a member 210, receiving transactional information for a purchase made by the member 210 using the member payment card 212, assigning a charitable donation to the member escrow account 218 for the member-selected charity 240 based on the purchase made by the member 210, and facilitating the transfer of the charitable contribution to the member-selected charity 240. The processor 504 displays on a secure webpage, a listing of charities available for selection and receives the identity of the member-selected charity 240 using an ICCD 203 as illustrated in FIG. 3 and described above. The system 501 determines a total amount in the member escrow account 218, determines whether the total amount in the member escrow account 218 exceeds a predetermined threshold, assigns a pre-paid debit card 242 to the member-selected charity 240, the pre-paid debit card 242 having a value of that deducted from the member escrow account, and sends the pre-paid debit card 242 to the member-selected charity 240. The processor 504 is further configured for receiving transaction information for the pre-paid debit cards and displaying the transactional information for the pre-paid debit card to the member.

The processor 504 is further configured for processing payment card transactions with merchants 214, receiving charity purchase information of a financial transaction 212 of a charity, retrieving charity profile information, retrieving charity compliance rules, and determining whether the financial transaction of a charity complies with the charity compliance rules. If the financial transaction of the charity does not comply with the charity compliance rules, alerting a donating party 210 of the lack of compliance. The charity compliance rules are based on one or more criteria including the function of the charity, the intended beneficiaries of the charity, the frequency of the purchase of specific items, and the supplier profile. The processor 504 is further configured for estimating a level of compliance of the transaction, and presenting the level of compliance of the transaction to a donating party.

FIG. 7 is a flow diagram 600 illustrating the overall process flow of a charitable donation system in an embodiment. The member 210 establishes a member account with the charitable donations facilitator 220 (step 601). The member 210 makes a purchase and the nominated charity receives a pre-paid debit card 242 (step 602). The purchase compliance monitoring module 260 tracks and analyzes the charity purchase for compliance (step 603). The charitable donations facilitator 220 updates the member's account and enables the member to view transaction details of the charity's purchase (step 604).

FIG. 8 is a flow diagram illustrating the process of establishing member accounts (step 601) in an embodiment. The member visits the charitable donations facilitator 220 website via an ICCD 203 as illustrated in FIG. 3 and described above and enters the member's payment card number and optionally indicates the eligibility for gift aid (step 701). The charitable donations facilitator 220 contacts and informs the payment card company 216 that member 210 has enrolled in the charity donations program (step 702). The charitable donations facilitator 220 contacts the member 210 when the member's charity donation has sufficient funds to make a donation (step 703).

FIG. 9 is a flow diagram illustrating the process of establishing a charitable donation based on the member's payment card loyalty contributions (step 602). The member makes a purchase at a merchant 214 using the member's payment card 212 (step 801). The payment card company 216 confirms that the member 210 is enrolled in the charity donation program (step 802). If confirmed, the payment card company 216 places the member's loyalty contribution in the payment card escrow account 218 (step 803). When the escrow account 218 has sufficient funding, the payment card company 216 transfers funds to the facilitator's account (step 804). A pre-paid debit card 242 is issued to the charity 240 (step 805). The charity 240 uses the pre-paid card 242 to make a purchase with suppliers 250 (step 806).

FIG. 10 is a flow diagram illustrating the process of monitoring the purchase by the member-selected charity 240 and informing the member of the purchase (step 603). The purchase compliance monitoring module 260 receives the charity's purchase transaction information (step 901). The purchase compliance monitoring module 260 retrieves the charity's history of transactions, restrictions, and other information for processing (step 902). The purchase compliance monitoring module 260 analyzes the charity's transactions based on the compliance rules (step 903). When a purchase appears to be potentially suspicious, the purchase compliance monitoring module 260 indicates an alert for the transaction (step 904). The purchase compliance monitoring module 260 sends transaction information to the charitable donations facilitator 220 (step 905). The charitable donations facilitator 220 updates the member's account with the transaction and alerts the member 210 to review the transaction (step 906).

FIG. 11 is a flow diagram 1001 illustrating the process of a incorporating a prize draw for incentivizing the member to continue participating in the charitable donation system. The facilitator receives funds from revenue sources and randomly places prize draws in member's accounts (step 1010). The facilitator informs the member of a prize draw and provides an opportunity to attract a matching donation from another member (step 1011). The facilitator updates a public page on the website to solicit a matching donation from another member to fund a donation either member's nominated charity (step 1012). If a matching donation is secured, the charity 240 receives donations from each of the participating members (step 1013).

The charitable donations systems do not solicit any members to encourage purchases or donations. The charitable donations systems do not sell data or rely on any commercial sponsorship to provide the service.

Thus, it will be appreciated that the charity donation systems described above serves to empower both the donating member and the charity. The member confidently knows that 100% of the donations will be used for charitable purchases as can be reasonably ascertained. The charitable donation system will monitor the charity purchase, access the validity of the purchases, and provide the member with the charity's purchase information. The charitable donation system provides the member-selected charities with additional funds without the need for further fund-raising activities.

In the foregoing embodiments, the charitable donation system offerings are wedded in the ability to pull different technologies to create a multi channel platform, which will allow it to (1) track donations, (2) alert the charitable donation system of inappropriate spending, (3) leverage payment card transactions to share itemized receipts of spending, (4) provide social crowd sourcing with community features for users and charities, (5) enable time limit setting so funds are withdrawn if spending are not used (or abused), (6) enable an aggregator of desired spending in order to positively impact purchasing power of supply chain, and (7) provide big data that can offers reporting and trends. The intention is to also create a social interface that excites the donor or potential donor to be more generous.

Conventional charity donations are typically made online with a payment card transaction, for example. The processing can vary in cost for the individual transaction management platforms, but sometimes the processing fees may be a high as 7%. Other conventional charities employ a payroll giving and fundraising specialist companies or individuals which charge fees. Unfortunately, in some cases the time to process the request may take 6-18 months to repay the cost of recruiting a donor before the donors' money is cash positive for the charity as funds allocated to making a difference. Piecemeal enablement processes have been and will continue to be engaged by third parties having preconditioned terms that the grant bodies and the major donors expect.

While attention is focused on charities that create fundraising success, attention is not drawn toward the outcome return as charities are least regulated on performance. However, the structures currently in place are so universal that the donor accepts them whether reluctantly or not. Customer demand for greater transparency and more value has always been there without a credible solution for small public donor donations. Even worse, the charity world may be, deliberately or by default, an institution that has many hidden agendas not always in the best interests of those they serve which includes the donor. Verification of funds donors raise does not have independent data assessment for credibility.

Cash donations (bucket collection) are not 100% transferred by volunteers where deductions are taken. For example, consider a stand located at an airport which states that 100% of donations at that desk were for a charity. However, events run at a cost and therefore 100% cannot have been donated, the charity would have had to pay for the equipment of the stand if not the space as well

In the UK alone, there are 180,000 registered charities and they all have different levels of credibility so donors will have difficulties in calibrating their charitable integrity and the value of their donation. A need exists to create a valued link between donors and the various charities to help inspire donors by giving them more confidence as embodiments disclosed herein work for any charity on behalf of members irrespective of the charities current practices.

Conventional cash-back schemes may be typically vendor centric in that the return is designed to induce new vendor customers to cash it in with them as they cannot use the payment elsewhere. Also participants have to use a commercial website designated for the purpose. A need exists for a new cash-back system that has no ties and supersedes any other discount scheme that may already be running or the member has the benefit of already.

A need exists to provide a better service, as donors continue with the bad practice of not knowing a better solution. Campaign specific fundraising does not normally report itemized ‘spend only’ outcome for that specific project if it was completed.

The foregoing embodiments of the charitable donation disclosed herein are intended to indirectly enhance the quality of life for those chosen to receive the benefit of the charitable donation from a member, but simultaneously create emotional value, as a donor reward, in knowledge of a good outcome, as the member knows the charitable donation system has created a guaranteed outcome of “good” that was created because of the charitable donation system. This is done by generating free funds to support enablement of “good” when addressing that requirement but also being able to create the same benefit to the donor on different terms but of similar value.

Embodiments above are based on generating “new” funds that can't be accessed without the charitable donation system. This is done by accessing merchant accounts (where the charitable donation system has contracts via cash back card) to enable them to make contributions to social good as a loyalty contributions or donations to that customer account. They then transfer the cash incentive to the purchasers' account.

The underlying purpose of the charitable donation system is to enjoy deeper emotional feeling by engaging with the charitable donation system as the values are symbiotic for the giver and receiver and neither has the greater betterment from the action.

Among the benefits of the embodiments include a free method of creating free charitable donations from spending on a payment card, at no cost to the donor member as the registered payment card holder. The recipient charity of donations doesn't have a behavior change in that any donations are supposed to be spent for the purpose of their existence. The entire program is based on a member directing the merchant to transfer cash in the form of a donation, at no expense to the donor, to their charity fund.

The charitable donation system is designed to be robust with charity transparency on member donation terms so that the private donors can validate their decision to donate with greater credible evidence on the conversion of their donation to a social investment.

Embodiments above act to disempower those that abuse or could possibly abuse the donor members' money as a generous act for charitable good, so the member then has greater control and knowledge of the expected outcome which was the reason they generated the donation in the first place via the charitable donation system. Embodiments offer to deliver an answer to common questions of a donor: “What happened to my donation. Did it make any difference?”

The foregoing embodiments act to enable donations, to a members chosen charity, to be generated from spending with merchants/retailers, and not to expect a member to pay anything from their savings or current earnings. These embodiments effectively engage with members, to help increase or enable the members charitable giving but at no cost to the member.

Embodiments above include aggregating many more features to entice potential members. Embodiments start with the concept into a charitable platform for members and increase the capability to achieve more value, but also to create a way it didn't need a new customer payment card.

The above embodiments include means to create a transaction card, chip and pin, that also held other commodities like discount coupons, reward points, free bonuses from merchants (like coffee) to reward members. Embodiments allow people generally or businesses to reward “givers” and charities by donating whatever they could so the charitable donation system could transfer to a member's card to enable them to gift the benefit for charitable use.

The payment card would be more that a way of transacting. The card would become a lifestyle management “tool” for an “emotional transfer” in that every transaction that was generated was by emotion before personal beneficial need or reward for self.

A goal of one or more embodiments is designed to be a way of creating “good” by being “good” to feel good—rather than be seen as a fundraiser.

The charitable donation system works for the member and represents clear transparent and recorded information so that the member can relate to trusted verification of what that transaction outcome was that they generated, or helped generate if their donation became an aggregated sum.

For most conventional donation approaches, there are no known ways that a private donor's donation can be verified independently under a value for money remit or whether that charity ‘spend’ was appropriate expenditure. Embodiments help solve this by reporting with visible evidence. This service is precisely why a donor would choose to become a member rather than donate direct to their favored charity, albeit they wouldn't secure any additional free donations if they did not take up membership.

There are many people who may not give to charity because they think it will not make a difference and they are not confident that the recipient won't spend the donation on self-interest (albeit legal) like covering advertising costs, before life enhancement for those they chose to serve. Embodiments can prove where and how a donation makes a difference and that the funds were spent, in accordance with the contractual terms, so then the member retains some control along the audit path rather than just handing over money and then have no further relationship or visibility of outcome specific even of any value add. They would have no knowledge if their donation had been deposited in a bank for the charity to gain interest.

Many conventional current and vaguely similar services, by close competitors, stop the donation empowerment when the donor transfers money to a charity—the donor is no longer empowered or connected to their donation and totally reliant on the charity to deliver. Embodiments change that, by following the audit trail representing the member so the donor continues their empowerment and has direct access to outcomes independently so members do not need to reply on the recipient charity which may perhaps provide information in a biased way.

Logic would suggest that being a member enhances the emotional feelings a person gets when they transact with their payment card as they also donate to charity simultaneous knowing the charitable donation system will deliver a guaranteed outcome that makes a difference within a timescale and with transparency together with efficient deployment, to maximize an outcome.

The member also knows that they are a perpetual fundraiser for their sponsored charity. The member will feel more empowered throughout the transaction, as the amount is tracked and reported with the knowledge that the charitable donation system has created a trusted platform for them to achieve this. The methodology is to gain “new money” for charity distribution and not target an individual's savings or earnings. A key point is the member does not change behavior.

The foregoing embodiments create an enjoyable and deep “emotional transfer” simultaneously with the giving process to reinforce the reason why the donor donates, but more particularly so they can secure more emotional value with the charitable donation system as their chosen partner in supporting value creation from their donation.

Although the invention has been discussed with reference to specific embodiments, it is apparent and should be understood that the concept can be otherwise embodied to achieve the advantages discussed. The preferred embodiments above have been described primarily as methods and systems for facilitating and monitoring charitable donation based on payment card loyalty contributions. In this regard, the foregoing description of the system and methods is present for purposes of illustration and description. Furthermore, the description is not intended to limit the invention to the form disclosed herein. Accordingly, variants and modifications consistent with the following teachings, skill, and knowledge of the relevant art, are within the scope of the present invention. The embodiments described herein are further intended to explain modes known for practicing the invention disclosed herewith and to enable others skilled in the art to utilize the invention in equivalent, or alternative embodiments and with various modifications considered necessary by the particular application(s) or use(s) of the present invention.

What is claimed is:

1. A method for facilitating charitable donations comprising:
employing one or more processors for:
enabling a member to select a member-selected charity for receiving a charitable donation based on a purchase made by the member using a member payment card;
receiving an identity of the member-selected charity and a member payment card information from the member;
receiving transactional information for the purchase involving the member payment card;
assigning the charitable donation to a member escrow account for the member-selected charity; and,
facilitating the transfer of the charitable contribution to the member-selected charity.

2. The method of claim 1, wherein receiving the identity of the member-selected charity and the member payment card information further comprises:
displaying on a secure webpage to the member, a listing of charities available for selection; and,
receiving the identity of the member-selected charity from the member using an Internet Connected Computing Device.

3. The method of claim 1, wherein facilitating the transfer of the charitable contribution to the member-selected charity further comprises:
calculating a total amount in the member escrow account;
determining whether the total amount in the member escrow account exceeds a predetermined threshold;
assigning a pre-paid debit card to the member-selected charity, the pre-paid debit card having a value of that deducted from the member escrow account; and,
sending the pre-paid debit card to the member-selected charity.

4. The method of claim 3, further comprising:
monitoring purchases made by the member-selected charity; and,
invalidating the pre-paid card if the charity has not made a purchase with the pre-paid card within a predetermined time period.

5. The method of claim 1, further comprising:
receiving transaction information for the pre-paid debit card made by the member-selected charity; and,
displaying the purchase information for the pre-paid debit card to the member.

6. The method of claim 5, further comprising:
providing a means for the member to object to the transaction information for the pre-paid card on basis of fraud;
receiving the member objection; and,
determining whether the transaction for the pre-paid card is fraudulent.

7. The method of claim 6, further comprising stopping a payment of the pre-paid transaction if the transaction has been determined to be fraudulent.

8. The method of claim 1, further comprising:
displaying on a secure webpage, a means for the member to elect to participate in a prize draw; and,
receiving a prize draw participation status.

9. The method of claim A8, further comprising:
receiving funds from revenue sources;
randomly assigning a portion of the funds into a member account; and,
notifying the member of assignment of the funds into a member account.

10. The method of claim 9, wherein at least a portion of the revenue sources comprise government refunds associated with charitable donations.

11. The method of claim 1, further comprising:
receiving from the member a request to solicit a matching donation from another member;
informing other members of the request to solicit the matching donation;
receiving a matching donation from said another member;
donating the member donation and the matching donation to the member-selected charity.

12. The method of claim 1, wherein the charitable donation comprises a loyalty contribution which is deducted from an associated payment to a merchant identified in the transactional information.

13. A charitable donation system, comprising: a memory comprising member and charity information;
a processor operably connected to the memory and a payment card processing system, the processor configured for:
receiving an identity of a member-selected charity and member payment card information from a member;
receiving transactional information from the payment card processing system for a purchase made by the member using the member payment card;
assigning a charitable donation to a member escrow account for the member-selected charity based on the purchase made by the member;
facilitating the transfer of the charitable contribution to the member-selected charity; and,
monitoring via the payment card company transactions associated with the charitable contribution.

14. The system of claim 13, wherein receiving the identity of the member-selected charity and the member payment card information further comprises:
displaying on a secure webpage, a listing of charities available for selection; and,
receiving the identity of the member-selected charity using an Internet Connected Computing Device.

15. The system of claim 13, wherein facilitating the transfer of the charitable contribution to the member-selected charity further comprises:
determining a total amount in the member escrow account;
determining whether the total amount in the member escrow account exceeds a predetermined threshold;
assigning a pre-paid debit card to the member-selected charity, the pre-paid debit card having a value of that deducted from the member escrow account; and,
sending the pre-paid debit card to the member-selected charity.

16. The system of claim 13, wherein the processor is further configured for:
receiving transaction information for the pre-paid debit cards; and,
displaying the transactional information for the pre-paid debit card to the member.

17. A charitable donation system, comprising:
a memory comprising member and charity information;
a processor operably connected to the memory and configured for:
processing payment card transactions with merchants;
receiving an identity of a member-selected charity and member payment card information from a member;
receiving transactional information for a purchase made by the member using the member payment card;
assigning a charitable donation to the member escrow account for the member-selected charity based on the purchase made by the member; and,
facilitating the transfer of the charitable contribution to the member-selected charity.

18. The system of claim 17, wherein receiving the member-selected charity and the member payment card information further comprises:
displaying on a secure webpage, a listing of charities available for selection; and,
receiving the identity of the member-selected charity using an Internet Connected Computing Device.

19. The system of claim 17, wherein facilitating the transfer of the charitable contribution to the member-selected charity further comprises:
determining a total amount in the member escrow account;
determining whether the total amount in the member escrow account exceeds a predetermined threshold;
assigning a pre-paid debit card to the member-selected charity, the pre-paid debit card having a value of that deducted from the member escrow account; and,
sending the pre-paid debit card to the member-selected charity.

20. The system of claim 17, wherein the processor is further configured for:
receiving transaction information for the pre-paid debit cards; and,
displaying the transactional information for the pre-paid debit card to the member.
